(19) United States
(12) Patent Application Publication
(10) Pub. No.: US 2001/0044716 A1
(43) Pub. Date: Nov. 22, 2001

(54) ENCODING AND DECODING SYSTEM USING CODE BOOKS

(75) Inventor: KEN?apos;ICHI YAMAUCHI, HAMAMATSU-SHI (JP)

Correspondence Address: ROGER R WISE, PILLSBURY MADISON AND SUTRO, 725 SOUTH FIGUEROA STREET, SUITE 1200, LOS ANGELES, CA, 900175443

(73) Assignee: YAMAHA CORPORATION

(21) Appl. No.: 08/942,837

(22) Filed: Oct. 2, 1997

(30) Foreign Application Priority Data
Oct. 4, 1996 (JP) 8-264002

(51) Int. Cl. G10L 19/12; G10L 21/00

(52) U.S. Cl. 704/222; 704/230

(57) ABSTRACT

In an encoding system, input audio data are subjected to vector quantization in accordance with a content of a code book to produce indexes. In addition, the encoding system produces a number of new pattern vectors which are suited to the audio data. Based on a result of the vector quantization, the encoding system determines a replacement candidate for a pattern vector which is registered with the code book. With respect to each of the new pattern vectors, code book renewal data are produced to represent a linear combination of pattern vectors which are registered with the code book other than the replacement candidate. Herein, the linear combination of pattern vectors has a distance which is the closest to the new pattern vector. Then, the replacement candidate of the pattern vector of the code book is replaced with a new pattern vector for replacement which is newly created based on the code book renewal data. Thus, it is possible to renew the content of the code book. A multiplexer collects the indexes and code book renewal data to provide a bit stream. Herein, the code book renewal data are arranged at a top portion of the bit stream. In a decoding system, the bit stream is partitioned into the indexes and code book renewal data. The indexes are subjected to reverse vector quantization in accordance with a content of a code book to reproduce the audio data. Using the code book renewal data, the content of the code book of the decoding system is renewed to correspond to the renewed content of the code book of the encoding system.

### BACKGROUND OF THE INVENTION

1. Field of the Invention

This invention relates to encoding and decoding systems which use code books to provide transmitting information in a compressive encoded form by performing vector quantization on original information representing sounds and/or pictures. Particularly, this invention relates to encoding and decoding systems which are capable of renewing contents of the code books in response to transmitting information.

2. Prior Art

The conventional technology of the encoding and decoding system (hereinafter, simply referred to as encoding-decoding system) uses the known technique of the vector quantization. Using the vector quantization, it is possible to transmit or record information of sounds and/or pictures in a compressive encoded form with a high efficiency. In the vector quantization, the system extracts every interval of information patterns to be quantized to provide a target vector. Then, the system selects a pattern vector which is the closest to the target vector within pattern vectors of a code book. So, the system transmits or records an index of the selected pattern vector. However, if a large minimum square error is calculated between the target vector and the pattern vectors of the code book, an amount of quantization noise is increased, so reproduction quality of original information (i.e., sound quality in reproduction of original information) should be lowered. For this reason, a set of pattern vectors are produced in consideration of a variety of input-information patterns in advance. Thus, the code book stores the above pattern vectors therein.

The code book should be changed in content or tendency of content when genre (or category) of a tune is changed in case of transmission of music information, or when a companion to phone (or speak) is changed in case of telephone communications. So, if a variety of pattern vectors are produced in consideration of all cases and are registered in the code book, it may be possible to improve the reproduction quality. In that case, however, an amount of information of the code book should be enormous. This raises a problem. That is, an amount of transmitting information is increased due to an increase of a number of bits of the index; and a search time is increased.

To solve the above problem, the conventional technology provides an adaptive system in which the code book can be adequately rewritten in content while regulating an amount of information accumulated therein not to be so much. For example, the paper of Japanese Patent Laid-Open Publication No. 2-186836 discloses an example of an “adaptive” encoding-decoding system. This system is designed to deal with a situation where an error calculated between an input vector and pattern vectors of the code book becomes larger than a threshold value which is determined in advance. In that situation, the input vector is directly transmitted, whereas a pattern vector which was selected from the code book in the most distant past is replaced with the input vector. Thus, the above system is capable of renewing the content of the code book in response to input information.

As described above, the conventional encoding-decoding system is designed to directly transmit the input vector and perform replacement of the pattern vector of the code book when the input vector is not suited to the existing pattern vector of the code book. So, if the input vectors are greatly changed in tendency, the conventional system suffers from a problem that an amount of transmitting information is rapidly increased.

### SUMMARY OF THE INVENTION

It is an object of the invention to provide an encoding-decoding system which is capable of efficiently renewing content of a code book in accordance with a small amount of transmitting information.

In an encoding system of this invention, input audio data are subjected to vector quantization in accordance with a content of a code book to produce indexes. In addition, the encoding system produces a number of new pattern vectors which are suited to the audio data. Based on a result of the vector quantization, the encoding system determines a replacement candidate for a pattern vector which is registered with the code book. With respect to each of the new pattern vectors, code book renewal data are produced to represent a linear combination of pattern vectors which are registered with the code book other than the replacement candidate. Herein, the linear combination of pattern vectors has a distance which is the closest to the new pattern vector. Then, the replacement candidate of the pattern vector of the code book is replaced with a new pattern vector for replacement which is newly created based on the code book renewal data. Thus, it is possible to renew the content of the code book. A multiplexer collects the indexes and code book renewal data to provide a bit stream. Herein, the code book renewal data are arranged at a top portion of the bit stream.

In a decoding system of this invention, the bit stream is partitioned into the indexes and code book renewal data. The indexes are subjected to reverse vector quantization in accordance with a content of a code book to reproduce the audio data. Using the code book renewal data, the content of the code book of the decoding system is renewed to correspond to the renewed content of the code book of the encoding system.

Incidentally, a small number of indexes and coefficients are sufficient for the code book renewal data because the code book renewal data represent the linear combination of the pattern vectors which have been already registered with the code books of the encoding system and decoding system. In other words, this invention requires a small amount of transmitting information for renewal of the code book which correspond to the code book renewal data. That is, it is possible to remarkably reduce the transmitting information.

Moreover, this invention performs transmission of the code book renewal data prior to transmission of the audio data. Hence, it is possible to renew the content of the code book of the decoding system prior to processing of the audio data. This does not require interrupt in decoding process regarding renewal of the code book. In other words, it is possible to avoid occurrence of an unintentional break in sounding.

### BRIEF DESCRIPTION OF THE DRAWINGS

These and other objects of the subject invention will become more fully apparent as the following description is read in light of the attached drawings wherein:

FIG. 1 is a block diagram showing a configuration of an encoding system in accordance with an embodiment of the invention;

FIG. 2 is a flowchart showing an algorithm for determination of replacement candidates;

FIG. 3 shows an example of a content of a code book which copes with the replacement candidates determined by the algorithm of FIG. 2;

FIG. 4 is a flowchart showing an algorithm for determination of code book renewal data;

FIG. 5 shows an example of a format of a bit stream which is produced by the encoding system;

FIG. 6 is a block diagram showing an example of a configuration of a decoding system which performs decoding of the bit stream output from the encoding system; and

FIG. 7 shows a modified example of the format of the bit stream.

### DESCRIPTION OF THE PREFERRED EMBODIMENT

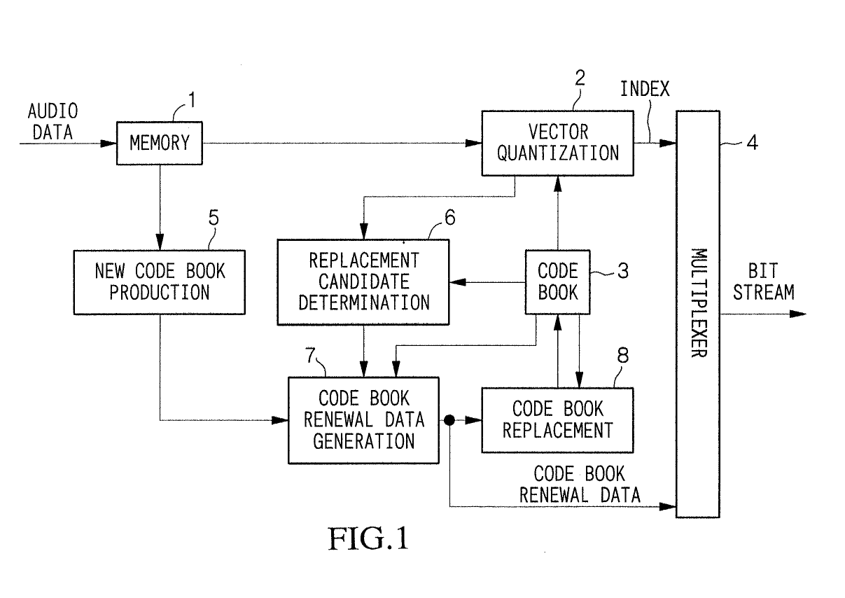

FIG. 1 is a block diagram showing a configuration of an encoding system within an encoding-decoding system in accordance with an embodiment of the invention.

The encoding system of FIG. 1 receives audio data. For example, the audio data correspond to PCM data (where ‘PCM’ is an abbreviation for ‘Pulse Code Modulation’) which are produced by performing analog-to-digital conversion on audio signals. Or, the audio data correspond to data representing frequency spectrum which is obtained by performing time-frequency orthogonal transformation of the PCM data. Or, the audio data correspond to data representing residual signals of the CELP method (where ‘CELP’ is an abbreviation for ‘Code-Excited Linear Prediction’). The audio data described above are once stored in a memory 1. Then, every frame of data are extracted from the stored audio data and are read from the memory 1. The read data are supplied to a vector quantization section 2 as a target vector. Pattern vectors are registered with a code book 3. So, the vector quantization section 2 selects a certain pattern vector, which approaches the target vector as close as possible, from among the pattern vectors of the code book 3. At an encoding mode, the vector quantization section 2 supplies an index corresponding to the selected pattern vector to a multiplexer 4. At a mode to generate code book renewal data (hereinafter, simply referred to as “code book renewal mode”), the vector quantization section 2 does not output the index of the selected pattern vector.

The target vector read from the memory 1 is supplied to a new code book production section 5, which in turn produces a certain number of new pattern vectors which match with the audio data input to the encoding system of FIG. 1. At the code book renewal mode, a replacement candidate determination section 6 determines replacement candidates of pattern vectors for the code book 3 on the basis of results of the vector quantization performed by the vector quantization section 2. A code book renewal data generation section 7 calculates a linear combination of pattern vectors which is the closest to the new pattern vector within linear combinations of pattern vectors which correspond to the pattern vectors registered with the code book 3 other than the replacement candidates. The above calculation is performed with respect to each of the new pattern vectors produced by the new code book production section 5. Then, the code book renewal data generation section 7 provides a combination of coefficients and indexes for the calculated linear combination of pattern vectors. Such a combination of the coefficients and indexes is output as code book renewal data. A code book replacement section 8 newly creates new pattern vectors for replacement based on the code book renewal data. So, the replacement candidates of pattern vectors of the code book 3 are replaced with the new pattern vectors in accordance with a replacement priority order. That is, a replacement candidate of a pattern vector given a high priority of replacement is replaced with a new pattern vector early. The code book renewal data are supplied to the multiplexer 4. The multiplexer 4 combines the code book renewal data and the indexes obtained by the vector quantization to produce a bit stream, which is then transmitted onto a transmission line (not shown).

Next, a description will be given with respect to operations of the encoding system of FIG. 1.

When receiving audio data, the encoding system sequentially performs two-stage processes which correspond to generation of code book renewal data and encoding of audio data respectively.

For example, when audio data representing music are input to the encoding system, the memory 1 stores a certain amount of audio data which correspond to a tune. Or, the memory 1 stores a number of measures of the tune which are sufficient for a human operator to grasp a certain degree of tendency in waveform patterns of the tune. Based on such an amount of audio data, code book renewal data are produced.

Specifically, the new code book production section 5 uses the known cluster ring method to produce a certain number of new pattern vectors which are suited to the audio data stored in the memory 1. At the same time, the vector quantization section 2 and the replacement candidate determination section 6 work together to determine replacement candidates of pattern vectors for the code book 3.

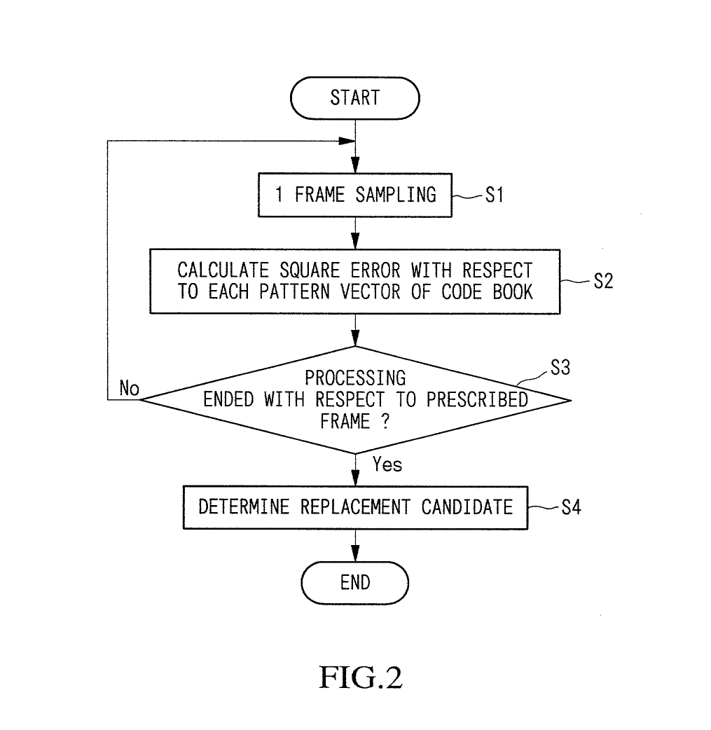

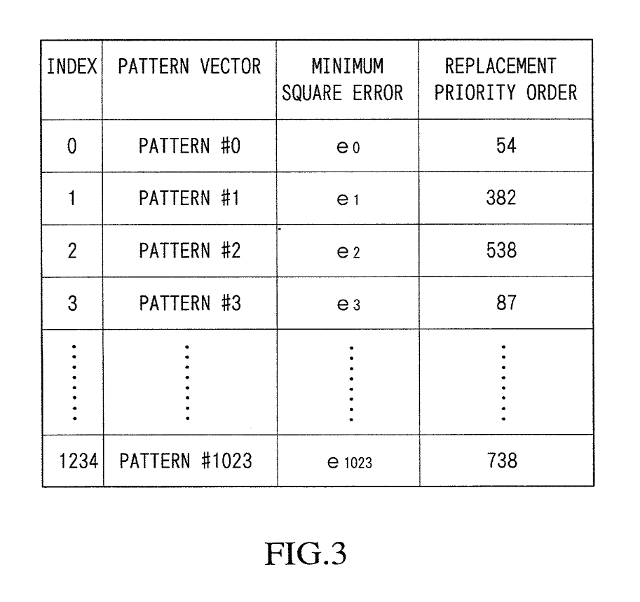

FIG. 2 is a flowchart showing an algorithm for determination of replacement candidates. In step S1, the encoding system performs sampling of audio data of 1 frame. In step S2, the vector quantization section 2 calculates a square error with respect to each of pattern vectors of the code book 3. This calculation is performed with respect to all of a number of target vectors which correspond to a certain number of frames of audio data stored in the memory 1 (see step S3). Thus, it is possible to lastly set a minimum square error with respect to the pattern vectors of the code book 3. As the minimum square error lastly set, it is possible to use an accumulated value, an average value or a minimum value which is calculated with respect to minimum square errors calculated for all frames. Based on the minimum square error lastly set, the encoding system determines a replacement priority order with respect to each of pattern vectors of the code book 3. In step S4, the encoding system determines replacement candidates of pattern vectors on the basis of the replacement priority orders. As a method to determine replacement candidates, for example, it is possible to employ two methods as follows:

According to a first method, determination of replacement candidates is carried out by sequentially choosing replacement candidates having higher replacement priority orders within a predetermined number of replacement candidates. According to a second method, the system determines a pattern vector whose minimum square error is greater than a predetermined threshold value as a replacement candidate. Herein, a number of the replacement candidates and the threshold value can be determined in accordance with a empirical method; or they can be determined in accordance with a trial-and-error method by a person (or persons) who actually listens to sounds, for example.

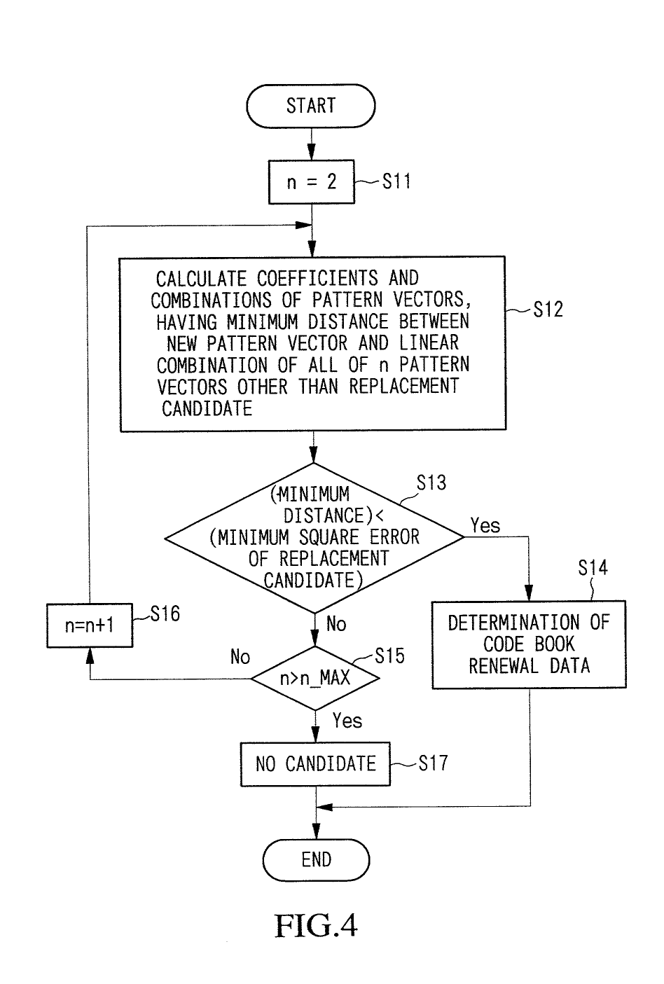

As described above, the replacement candidates of pattern vectors are determined for the code book 3. Then, the encoding system determines coefficients and pattern vectors of the code book 3 to provide representation of a new code book (or a new content of the code book) in linear-combination forms. FIG. 4 is a flowchart showing an algorithm which relates to determination of the coefficients and pattern vectors.

The encoding system performs processing represented by the algorithm of FIG. 4 with respect to all of new pattern vectors which are produced by the new code book production section 5. Given a new pattern vector to be processed, ‘2’ is set as an initial value of ‘n’ which represents a number of pattern vectors used in the processing of FIG. 4 (see step S11). The system extracts all combinations of ‘n’ pattern vectors, which do not correspond to the replacement candidates, from the code book 3 as linear combinations of pattern vectors. Then, the system calculates distances with respect to all of the extracted combinations of the pattern vectors. Thus, the system calculates a combination of pattern vectors and its coefficients with respect to a minimum distance within the calculated distances (see step S12).

The above operation will be described in a more concrete manner with respect to the case where n=2 and a numeral of “code_new[i]” represents a new pattern vector to be processed whose number in replacement priority order is “i”. In that case, ‘n(=2)’ pattern vectors are represented by numerals of “code_old[index j]” and “code_old[index k]”. The system calculates a distance “Djk” with respect to all combinations of j, k in accordance with an equation represented by [Math 1] as follows:

[Math 1]

Djk={code_new[i]−(ajk*code_old[index j]+bjk*code_old[index k])}²

The above calculation of the distance Djk is performed with respect to all combinations of j and k. Then, the system calculates indexes j, k and coefficients ajk, bjk with respect to a combination of pattern vectors having a minimum distance within the calculated distances.

Step S13 indicates a condition where the calculated minimum distance Djk is smaller than a minimum square error of a replacement candidate for the number “i” of the replacement priority order. In that condition, the system determines the indexes j, k and coefficients ajk, bjk, calculated for the combination of pattern vectors having the minimum distance Djk, as code book renewal data (see step S14). On the other hand, if the minimum distance Djk is not less than the minimum square error of the replacement candidate, a program control goes to step S15 from step S13. In that case, a number of ‘n’ is increased to repeat the aforementioned processes (e.g., step S12) until a number of combinations of pattern vectors becomes greater than a number represented by a numeral of “n_MAX” (see steps S15 and S16). By the way, if the system fails to find out an optimum linear combination of pattern vectors through repetition of the aforementioned steps, it can be said that replacement is not necessarily required for the replacement candidate having the number “i” of the replacement priority order. So, the system declares a statement of “no candidate” in step S17. Then, the system completes processing of the algorithm of FIG. 4.

Through execution of the algorithm of FIG. 4 described above, it is possible to obtain code book renewal data. If a numeral of “index 1” represents an index of the pattern vector having the number i of the replacement priority order, the code book replacement section 8 is capable of renewing the code book 3 in accordance with an equation of [Math 2] as follows:

[Math 2]

code_new[index l]=ajk*code_old[index j]+bjk*code_old[index k]

Five numbers corresponding to index l, ajk, index j, bjk and index k are sufficient for information which should be transmitted to a decoding system as the code book renewal data.

If renewal of the code book 3 completes, every frame of audio data are read from the memory 1 again. Using the renewed code book 3, the encoding system performs vector quantization of the audio data so as to provide indexes, which are then supplied to the multiplexer 4.

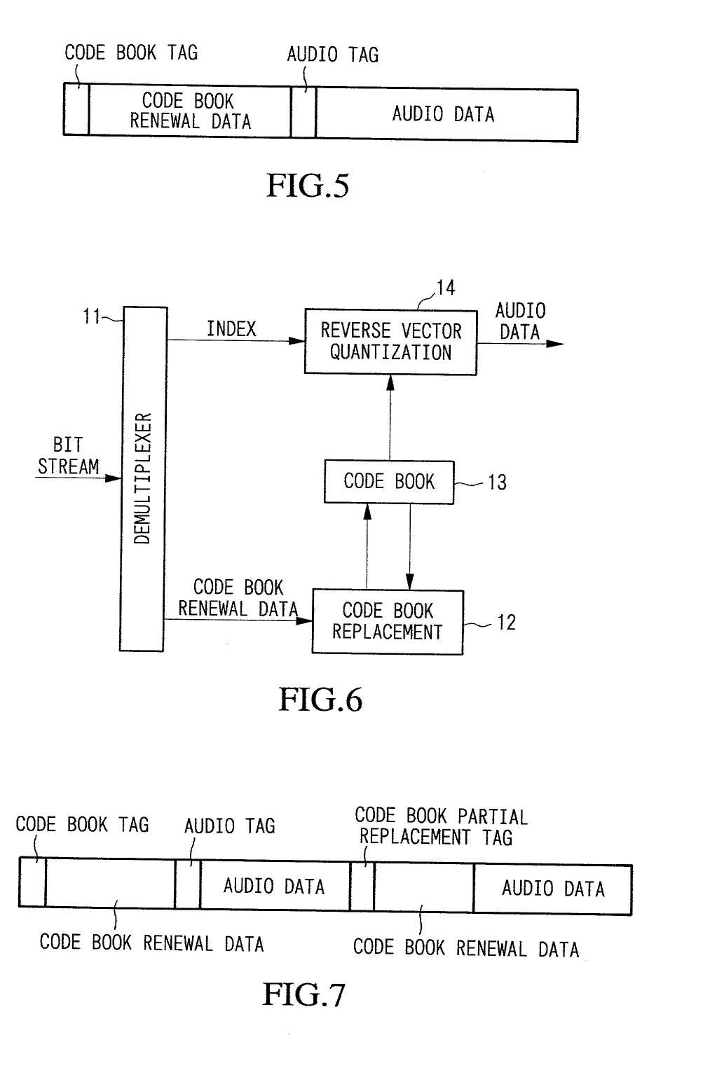

FIG. 5 shows a format of a bit stream which is produced by the multiplexer 4.

In FIG. 5, a code book tag indicates that the present bit stream correspond to data which are used for replacement of the code book. This code book tag is transmitted as a first element of the bit stream. Following the code book tag, code book renewal data are transmitted to the decoding system. Then, an audio tag is transmitted to indicate that transmission of audio data is made. Lastly, the audio data, containing indexes, are transmitted to the decoding system. Herein, an encoding process is carried out using the renewed code book to produce the above audio data.

FIG. 6 is a block diagram showing an example of a configuration of the decoding system.

The decoding system of FIG. 6 receives the aforementioned bit stream which is transmitted thereto from the encoding system. Herein, a demultiplexer 11 partitions the bit stream into the code book renewal data and the audio data (i.e., indexes). The code book renewal data are supplied to a code book replacement section 12. The code book replacement section 12 performs a similar process of the aforementioned code book replacement section 8 of the encoding system. Thus, content of a code book 13 is renewed. On the other hand, the indexes are supplied to a reverse vector quantization section 14. Using the renewed code book 13, the reverse vector quantization section 14 decodes the indexes to reproduce audio data.

By the way, the present embodiment is designed under the precondition that the encoding system and decoding system respectively provide the code books 3 and 13 both of which have the same content. For this reason, an initial code book is provided for the encoding system and decoding system respectively in advance. When starting transmission, the encoding system performs initialization of the code book 3 while transmitting initialization instruction data to the decoding system. That is, it is necessary to make the code book 3 of the encoding system and the code book 13 of the decoding system to coincide with each other in content.

The operation of the present embodiment can be summarized as follows:

The code book renewal data are produced based on the audio data which should be transmitted. Prior to transmission of the audio data in an encoded form, the encoding system transmits the code book renewal data to the decoding system. Using the code book renewal data, the code books 3 and 13 are renewed. Then, the encoding system transmits the audio data in the encoded form.

Thus, even if genre of a tune changes, it is possible to perform high-quality decoding using a minimum amount of accumulation of pattern vectors. In addition, the code book renewal data are given by linear combinations of the pattern vectors which have been already stored in the encoding system and decoding system. So, the present embodiment is capable of renewing a plenty of pattern vectors by using an extremely small amount of transmitting information.

Incidentally, the present embodiment starts transmission of the audio data after replacement of pattern vectors completes with respect to all of the replacement candidates for the code books 3 and 13. However, the operation of the present embodiment can be modified to cope with a situation where the minimum square error increases so much during transmission of the audio data. That is, the aforementioned processing of FIG. 2 and FIG. 4 is executed to renew the code books, so that the encoding system transmits the code book renewal data to the decoding system at an adequate timing. In that case, the encoding system outputs a bit stream having a format shown in FIG. 7, for example. That is, the system provides a code book partial replacement tag for partial replacement of pattern vectors of the code book. In addition, the system provides code book renewal data which correspond to the pattern vectors to be partially replaced. So, the code book partial replacement tag and its code book renewal data are inserted into the bit stream in the middle of the audio data.

Further, the present embodiment is designed such that the encoding system of FIG. 1 determines the replacement candidate based on the minimum square error which are calculated by the vector quantization section 2. For example, the present embodiment can be modified as follows:

The encoding system calculates a minimum square error for each of pattern vectors of the code book 3 with respect to each of pattern vectors produced by the new code book production section 5. So, the replacement candidate is determined based on a result of the above calculation.

Moreover, the present embodiment describes encoding and decoding processes with respect to the audio data. However, application of this invention is not limited to the audio data. In other words, the encoding and decoding processes of this invention can be applied to data of pictures (or images) as well.

Lastly, applicability of this invention can be extended in a variety of ways. For example, the memory of the embodiment can be replaced with other kinds of storage media such as CD-ROMs, magneto-optics disks, floppy disks and hard disks. Or, programs and data (e.g., contents of the code books) of this invention can be stored in the storage media. Further, the encoding-decoding system of this invention can be linked with a server computer via a communication network such as a local area network (LAN), a computer network such as “internet” and telephone lines. So, programs and data of this invention can be down-loaded to the system from the server computer via the communication network.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to be embraced by the claims.

What is claimed is:

1. An encoding-decoding system comprising:
an encoding system for performing vector quantization on transmitting information by using a code book so as to provide an encoded output; and
a decoding system for performing reverse vector quantization on the encoded output of the encoding system by using a code book which corresponds to the code book of the encoding system, so that the decoding system decodes the encoded output of the encoding system to reproduce the transmitting information,
wherein vector renewal information represented by a linear combination of vectors which are registered with the code book of the encoding system and the code book of the decoding system is transmitted from the encoding system to the decoding system, so that the code book of the encoding system and the code book of the decoding system are renewed in contents thereof.

2. An encoding-decoding system according to claim 1 wherein the encoding system comprises:
new code book production means for producing new vector information for the code book on the basis of the transmitting information;
replacement candidate determination means for determining replacement candidate of vector information which is replaced on the basis of the transmitting information;
code book renewal data generation means for generating code book renewal data, represented by a linear combination of vectors registered with the code book of the encoding system, with respect to the new vector information produced by the new code book production means; and
code book replacement means for replacing the replacement candidate of the vector information which is determined by the replacement candidate determination means with new vector information which is generated based on the code book renewal data which are generated by the code book renewal data generation means,
wherein a plurality of code book renewal data regarding all of replacement candidates of vector information are arranged at a top portion of the encoded output of the encoding system which is transmitted to the decoding system.

3. An encoding-decoding system in which an encoding system performs an encoding process on input data thereof while a decoding system performs a decoding process on an encoded output of the encoding system, wherein the encoding system comprises:
new patter vector producing means for producing a number of new pattern vectors which are suited to the input data input to the encoding system;
vector quantization means for performing vector quantization on the input data in accordance with a content of a code book to produce indexes;
replacement candidate determining means for determining a replacement candidate for a pattern vector which is registered with the code book on the basis of a result of the vector quantization;
code book renewal data generating means for generating code book renewal data with respect to each of the new pattern vectors, wherein the code book renewal data correspond to a linear combination of pattern vectors which are selected from among a plurality of pattern vectors registered with the code book other than the replacement candidate;
code book replacement means for replacing the replacement candidate of the pattern vector of the code book with a new pattern vector for replacement which is newly created based on the code book renewal data; and
multiplexer means for collecting the indexes and the code book renewal data to provide a bit stream as the encoded output of the encoding system, wherein the code book renewal data are arranged at a top portion of the bit stream.

4. An encoding-decoding system according to claim 3 wherein the decoding system comprises:
demultiplexer means for partitioning the bit stream transmitted thereto from the encoding system into the indexes and the code book renewal data;
reverse vector quantization means for performing reverse vector quantization on the indexes in accordance with a content of a code book, corresponding to the code book of the encoding system, to reproduce the input data of the encoding system; and
code book replacement means for performing replacement of a pattern vector of the code book on the basis of the code book renewal data.

5. An encoding-decoding system according to claim 3 wherein the linear combination of pattern vectors has a distance which is the closest to the new pattern vector.

6. An encoding-decoding system according to claim 3 wherein the code book replacement means performs replacement of the pattern vector with respect to the replacement candidate in accordance with a replacement priority order which is determined based on a minimum square error calculated between the input data and the pattern vectors of the code book.

7. An encoding-decoding system according to claim 3 wherein the input data input to the encoding system correspond to audio information such as music information.

8. An encoding-decoding system comprising:
encoding means for performing vector quantization on transmitting information by using a code book so as to provide an encoded output; and
decoding means for performing reverse vector quantization on the encoded output of the encoding means by using a code book which corresponds to the code book of the encoding means, so that the decoding means decodes the encoded output of the encoding means to reproduce the transmitting information,
wherein vector renewal information represented by a linear combination of vectors which are registered with the code book of the encoding means and the code book of the decoding means is transmitted from the encoding means to the decoding means, so that the code book of the encoding means and the code book of the decoding means are renewed in contents thereof.

9. An encoding-decoding method comprising the steps of:
performing vector quantization on transmitting information by using a first code book for encoding so as to provide an encoded output;
transmitting the encoded output corresponding to the transmitting information;
performing reverse vector quantization on the encoded output by using a second code book for decoding which corresponds to the first code book;
thus decoding the encoded output to reproduce the transmitting information;
transmitting vector renewal information represented by a linear combination of vectors which are registered with the first code book and the second code book respectively; and
renewing contents of the first code book and the second code book in response to the vector renewal information.

10. An encoding-decoding method according to which an encoding system performs an encoding process on input data thereof while a decoding system performs a decoding process on an encoded output of the encoding system, the encoding-decoding method comprising the steps of:
producing a number of new pattern vectors which are suited to the input data input to the encoding system;
performing vector quantization on the input data in accordance with a content of a code book of the encoding system to produce indexes;
determining a replacement candidate for a pattern vector which is registered with the code book on the basis of a result of the vector quantization;
generating code book renewal data with respect to each of the new pattern vectors, wherein the code book renewal data correspond to a linear combination of pattern vectors which are selected from among a plurality of pattern vectors registered with the code book other than the replacement candidate;
replacing the replacement candidate of the pattern vector of the code book with a new pattern vector for replacement which is newly created based on the code book renewal data; and
collecting the indexes and the code book renewal data to provide a bit stream as the encoded output of the encoding system, wherein the code book renewal data are arranged at a top portion of the bit stream.

11. An encoding-decoding method according to claim 10 further comprising the steps of:
partitioning the bit stream, which is transmitted from the encoding system to the decoding system, into the indexes and the code book renewal data;
performing reverse vector quantization on the indexes in accordance with a content of a code book of the decoding system, corresponding to the code book of the encoding system, to reproduce the input data of the encoding system; and
performing replacement of a pattern vector of the code book on the basis of the code book renewal data.

12. A machine-readable media storing programs and data which cause an encoding-decoding system to execute an encoding-decoding method comprising the steps of:
performing vector quantization on transmitting information by using a first code book for encoding so as to provide an encoded output;
transmitting the encoded output;
performing reverse vector quantization on the encoded output by using a second code book for decoding which corresponds to the first code book for encoding;
thus decoding the encoded output to reproduce the transmitting information;
transmitting vector renewal information represented by a linear combination of vectors which are registered with the first code book and the second code book; and
renewing contents of the first code book and the second code book in response to the vector renewal information.
